(19) United States
(12) Patent Application Publication
(10) Pub. No.: US 2024/0394506 A1
(43) Pub. Date: Nov. 28, 2024

(54) UNCERTAINTY ESTIMATION FOR NEURAL NETWORKS USING GRAPHICAL REPRESENTATION

(71) Applicant: SRI International, Menlo Park, CA (US)

(72) Inventors: Han-Pang CHIU, West Windsor, NJ (US); Yi YAO, Princeton, NJ (US); Angel DARUNA, Davie, FL (US); Yunye GONG, West Windsor, NJ (US); Abhinav RAJVANSHI, Plainsboro, NJ (US); Giedrius BURACHAS, Doylestown, PA (US)

(21) Appl. No.: 18/672,221

(22) Filed: May 23, 2024

Related U.S. Application Data
(60) Provisional application No. 63/468,726, filed on May 24, 2023.

(51) Int. Cl. G06N 3/042

(52) U.S. Cl. CPC G06N 3/042

(57) ABSTRACT

A method, apparatus, and system for determining an uncertainty estimation of at least one layer of a neural network includes identifying a neural network to be analyzed, representing values of each layer of the neural network as respective variable nodes in a graphical representation of the neural network, and modeling connections among each of the layers of the neural network as different respective factors across the variable nodes in the graphical representation, the graphical representation to be used to determine the uncertainty estimation of at least one layer of the neural network. The method, apparatus, and system can further include propagating data through the graphical representation to determine the uncertainty estimation of the neural network.

### CROSS-REFERENCE TO RELATED APPLICATIONS

This application claims benefit of and priority to U.S. Provisional Patent Application Ser. No. 63/468,726, filed May 24, 2023.

### GOVERNMENT RIGHTS

This invention was made with Government support under contract number HR0011-22-9-0110, awarded by the Defense Advanced Research Projects Agency (DARPA). The Government has certain rights in this invention.

### FIELD OF THE INVENTION

Embodiments of the present principles generally relate to determining accurate statistical models of Machine Learning (“ML”) systems and, more particularly, to a method, apparatus and system for determining uncertainty propagation of neural networks using graphical representations, such as factor graphs.

### BACKGROUND

Uncertainty Propagation in deep learning seeks to estimate the predictive uncertainty induced by aleatoric uncertainty. However, current methods for the aleatoric uncertainty estimation of neural networks present a challenging problem precluding the use of neural networks within safety-critical applications. That is, neural networks present a method for processing physical sensor data, improving over traditional methods in many domains, such as inertial odometry. Despite such advancements, extracting predictive uncertainty estimates from trained neural networks remains a challenge. As a result, incorporating neural networks within safety-critical applications that combine many predictions using their uncertainties (e.g. Kalman filtering) remains an open question. Predictive uncertainty is typically modeled as two separate uncertainties: epistemic and aleatoric uncertainty. Aleatoric uncertainty stems from environmental variations and sensor noise; hence, aleatoric uncertainty cannot be reduced through model improvements.

Several prior works attempt to propagate input uncertainties by modeling the input and output distributions as Gaussian. In some prior works the first two moments have been propagated both layer-wise and across entire neural networks using the unscented transform. In some works, Lightweight Probabilistic Networks were used to propagate the first two moments analytically while ignoring correlations of weight dimensions within layers (i.e. diagonal covariance matrices). In some prior works, an Extend Kalman Filtering formulation enabled the analytic propagation of the first two moments layer-wise while modeling correlations of weight dimensions within layers (i.e. full covariance matrix). Furthermore, some prior works propagated input uncertainties by instead modeling the input and output distributions as Gaussian mixtures and propagating uncertainties layer-by-layer or across the deep neural network. However, all of the prior works fail to model flows within deep neural networks, such as skip connections, and, as such, fail to accurately estimate the predictive uncertainty induced by aleatoric uncertainty. Even further, prior art works require a modification of the original neural network to determine uncertainties.

### SUMMARY

Embodiments of the present principles provide a method, apparatus and system for determining uncertainty propagation through deep neural networks using graphical representations, such as factor graphs.

In some embodiments, a method for determining an uncertainty estimation of at least one layer of a neural network includes identifying a neural network to be analyzed, representing values of each layer of the neural network as respective variable nodes in a graphical representation of the neural network, and modeling connections among each of the layers of the neural network as different respective factors across the variable nodes in the graphical representation, the graphical representation to be used to determine the uncertainty estimation of at least one layer of the neural network.

In some embodiments, the method can further include propagating data through the graphical representation to determine the uncertainty estimation of the neural network.

In some embodiments, an apparatus for determining an uncertainty estimation of at least one layer of a neural network includes a processor, and a memory accessible to the processor, the memory having stored therein at least one of programs or instructions executable by the processor to configure the apparatus to identify a neural network to be analyzed, represent values of each layer of the neural network as respective variable nodes in a graphical representation of the neural network, and model connections among each of the layers of the neural network as different respective factors across the variable nodes in the graphical representation. In some embodiments, the apparatus can further be configured to propagate data through the graphical representation to determine the uncertainty estimation of the neural network.

In some embodiments, a non-transitory computer readable medium having stored thereon at least one program, the at least one program including instructions which, when executed by a processor, cause the processor to perform a method for determining an uncertainty estimation of at least one layer of a neural network including identifying a neural network to be analyzed, representing values of each layer of the neural network as respective variable nodes in a graphical representation of the neural network, and modeling connections among each of the layers of the neural network as different respective factors across the variable nodes in the graphical representation, the graphical representation to be used to determine the uncertainty estimation of at least one layer of the neural network.

In some embodiments, the method of the non-transitory computer readable medium can further include propagating data through the graphical representation to determine the uncertainty estimation of the neural network.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1A depicts a high-level block diagram of a graphical representation formulation system in accordance with an embodiment of the present principles.

FIG. 1B depicts a graphical representation of a functionality of a graphical representation formulation system in accordance with an embodiment of the present principles.

FIG. 2A depicts a graphical representation of a functionality of a graphical representation formulation system in accordance with an alternate embodiment of the present principles.

FIG. 2B depicts an embodiment of the functionality of the graphical representation formulation system of FIG. 2A implemented as a two-phase process in accordance with an embodiment of the present principles.

FIG. 2C depicts a high-level diagram of a dense DNN that was pruned into a learned Sparse network in accordance with one embodiment of the present principles.

FIG. 3 depicts a high-level block diagram of a transformer network and a graphical representation of the transformer network in accordance with an embodiment of the present principles.

FIG. 4 depicts a graph formulation that can capture the structure of multi-head self-attention and residual connections in accordance with an embodiment of the present principles.

FIG. 5 depicts a high-level block diagram of a concatenated DNN-based subsystem and a graphical representation in accordance with an embodiment of the present principles.

FIG. 6 depicts an original MNIST image and four examples of the MINST image having different values of noise added.

FIG. 7 depicts a Table of the results of an ablation study performed in an experiment of a graphical representation formulation system in accordance with an embodiment of the present principles.

FIG. 8 depicts a Table depicting the MNIST Uncertainty Propagation Performance for MLP output and 3rd layer measured using 2-Wasserstien Distance in a graphical representation formulation system in accordance with an embodiment of the present principles.

FIG. 9 depicts a Table of CIFAR-10 Uncertainty Propagation Performance for ResNet18 measured using 2-Wasserstien Distance for a graphical formulation system in accordance with an embodiment of the present principles.

FIG. 10 quantitatively summarizes the uncertainty propagation using Graph formulation of the present principles providing improved performance over the other tested baselines in CIFAR-10 experiments in accordance with an embodiment of the present principles.

FIG. 11 depicts two graphical examples of uncertainty propagation on the above described inertial odometry network showing 3000 Monte Carlo samples as gray points with 1- and 2-standard deviation uncertainty ellipse for the output uncertainty estimated by each uncertainty propagation method of the present principles.

FIG. 12 depicts a flow diagram of a method for determining an uncertainty estimation of at least one layer of a neural network in accordance with an embodiment of the present principles.

FIG. 13 depicts a high-level block diagram of a computing device suitable for use with a graphical representation formulation system in accordance with embodiments of the present principles.

FIG. 14 depicts a high-level block diagram of a network in which embodiments of a graphical representation formulation system in accordance with the present principles can be applied.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for determining uncertainty propagation through neural networks using graphical representations, such as factor graphs. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles are described with respect to specific neural networks and representative factor graphs, embodiments of the present principles can be implemented in substantially any neural networks having any architecture, which can be modeled in accordance with the present principles using other graphical representations other than factor graphs and without the need to modify the neural networks.

Embodiments of the present principles implement graphical representations that naturally encode the factored nature of probability densities over multiple variables and their interactions, such as factor graphs, to model neural network uncertainty propagation. That is, in some embodiments Factor Graphs (FG), which are probabilistic Bayesian graphical models, can be used to evaluate the probability density of a state, find a local maximum of a posterior distribution, and sample states from a probability density.

More specifically, embodiments of the present principles can use factor graphs to model neural network uncertainty propagation as a non-linear optimization problem. In some embodiments, a factor graph is instantiated for a trained deep neural network that is the target for uncertainty propagation. In embodiments of the present principles, a factor graph can be formulated by treating network layers as discrete time steps and their values as variable nodes. Connections can be modeled among layers as different factors across variable nodes. In a graphical representation of the present principles, such as a factor graph, the connections can be modeled using Jacobian matrices, which encode partial derivatives with respect to components of interacting variables. The values of Jacobian matrix elements for each factor comes from the weights and biases across correspondent layers of a trained neural network. In such embodiments, the output covariance of the neural network can be accurately estimated by propagating input uncertainty through the network using, for example, the factor graph variable nodes and factors. It should be noted that, in accordance with the present principles, the neural network architecture complexities and training procedures are unaffected by the uncertainty propagation technique of the present principles because the graphical representation is external to the trained neural network. This capability enables uncertainty estimation to be post-hoc for fully trained networks and network augmentation and retraining is not necessary.

In accordance with the present principles, a graph representation is used to model an uncertainty estimation of a neural network. For example, in some embodiments of the present principles, a factor graph formulation is implemented to model deep neural network uncertainty propagation, by treating the network layers as discrete time steps and their values as variable nodes. Formally, a factor graph is a bipartite graph, F=( [symbol] , V, ε), with at least two types of nodes: factors ϕᵢ∈ [symbol] and variables xⱼ∈V. Edges, eᵢⱼ∈ε, encode independence relationships and are always between-factor nodes and variables nodes. A factor graph, F, can define a factorization of a global function, ϕ(X), according to Equation one (1), which follows:

$$ϕ ( X ) = {\prod }_{i} {ϕ}_{i} ( {X}_{i} ) , \qquad ( 1 )$$

where the factors are functions of an assignment of only adjacent variables, Xᵢ, in Equation one (1), connected via edges, for example, ∃eᵢⱼ∀xⱼ∈Xᵢ.

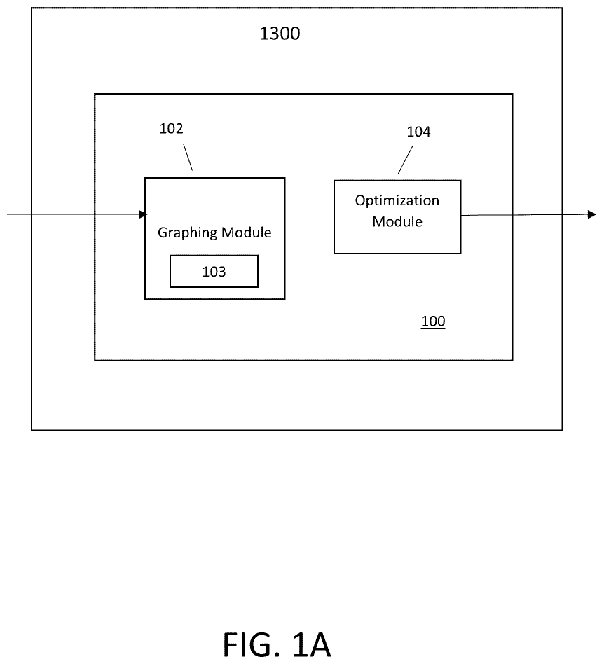

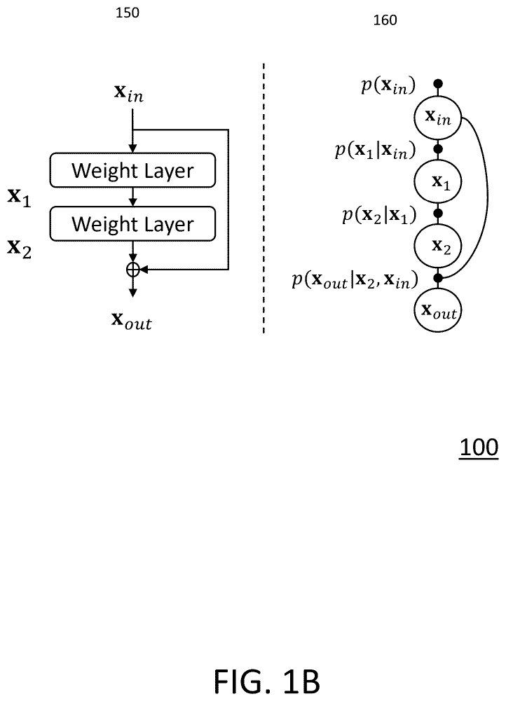

FIG. 1A depicts a high-level block diagram of a graphical representation formulation system 100 in accordance with an embodiment of the present principles. The graphical representation formulation system 100 of FIG. 1A illustratively comprises a graphing module 102 and an optimization module 104. In the embodiment of FIG. 1A, the graphing module 102 can include a machine learning model/algorithm 103 (described in greater detail below). As depicted in FIG. 1A, embodiments of a graphical representation formulation system of the present principles, such as the graphical representation formulation system 100 of FIG. 1A, can be implemented via a computing device 1300 (described in greater detail below) in accordance with the present principles.

FIG. 1B depicts a graphical representation of a functionality of a graphical representation formulation system of the present principles, such as the graphical representation formulation system 100 of FIG. 1A, in accordance with an embodiment of the present principles. The graphical representation formulation system of FIG. 1B models a neural network 150 using a graphical representation, illustratively a factor graph 160, to estimate predictive uncertainty caused by data uncertainty (e.g., aleatoric uncertainty) in accordance with an embodiment of the present principles. In the embodiment of FIG. 1B, the graphical representation formulation system was formulated in accordance with the present principles to correspond to a residual-block of a residual network (ResNet). In the embodiment of FIG. 1B, the features of each layer j in the neural network 150 are represented as variable node vectors xⱼ. In the embodiment of FIG. 1B, connections among network layers are formulated as different factors ϕᵢ(Xᵢ) among adjacent variable nodes. That is, in embodiments of the present principles, the graphical representation formulation system of FIG. 1B formulates a factor graph, F=( [symbol] , V, ε), which can model the input, output, and intermediate features in a neural network (e.g., a deep neural network) as variable nodes, Xⱼ∈V, and defines different factor nodes, ϕᵢ∈ [symbol] , based on layer connections (i.e. edges eᵢⱼ within the factor graph).

The graphical representation formulation system of FIG. 1B directly translates the neural network into a factor graph. In some embodiments of the present principles, a neural network can be translated into a graphical representation of the present principles, such as a factor graph, using for example, an input device (e.g., graphical user interface (not shown)) of the computing device 1300. That is, in some embodiments, a user of a graphical representation formulation system of the present principles can translate a neural network to be analyzed into a graphical representation, such as a factor graph, manually.

Alternatively or in addition, in some embodiments of the present principles, a neural network can be translated into a graphical representation of the present principles, such as a factor graph, using a machine learning model/algorithm. For example and as depicted in the embodiment of FIG. 1A, in some embodiments, the graphing module 102 can include a machine learning model/algorithm 103 trained to translate neural networks into a graphical representation, such as a factor graph, in accordance with the present principles. That is, in accordance with the present principles and as depicted in FIG. 1A, the machine learning (ML) model/algorithm 103 of the graphing module 102 can be trained to recognize neural network architectures and translate the neural network(s) into a graphical representation, such as a factor graph, in accordance with the present principles. In some embodiments, the ML model/algorithm 103 can be a multi-layer neural network comprising nodes that are trained to have specific weights and biases. In some embodiments, the ML model/algorithm 103 employs artificial intelligence techniques or machine learning techniques to analyze neural networks. In some embodiments in accordance with the present principles, suitable machine learning techniques can be applied to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Se2oSeq’ Recurrent Neural Network (RNNs)/Long Short-Term Memory (LSTM) networks, Convolution Neural Networks (CNNs), graph neural networks applied to the abstract syntax trees corresponding to the sequential program application, Transformer, such as encoder-only and decoder-only Transformers, NB Transformers, and the like. In some embodiments a supervised ML classifier could be used such as, but not limited to, Multilayer Perceptron, Random Forest, Naive Bayes, Support Vector Machine, Logistic Regression and the like. In addition, in some embodiments, the ML algorithm of the present principles can implement at least one of a sliding window or sequence-based techniques to analyze data.

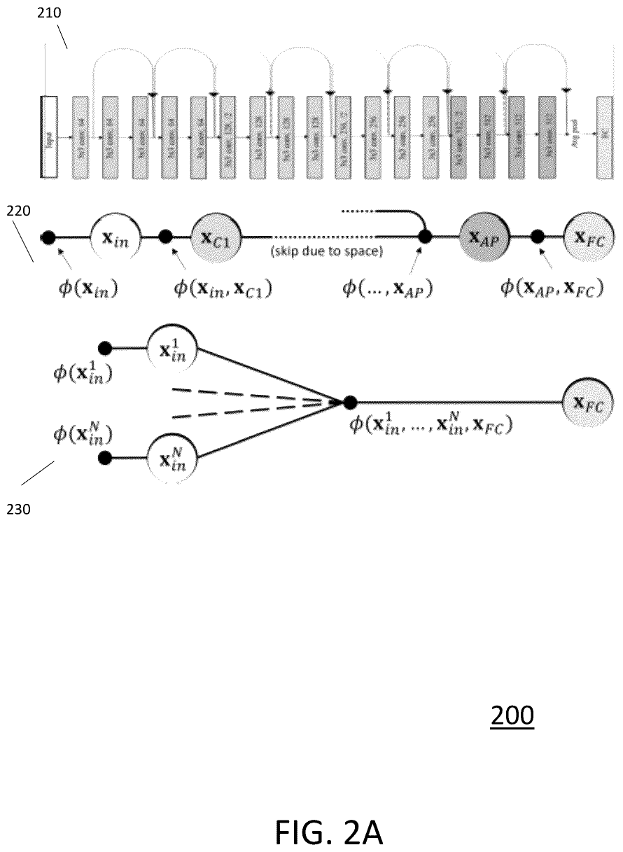

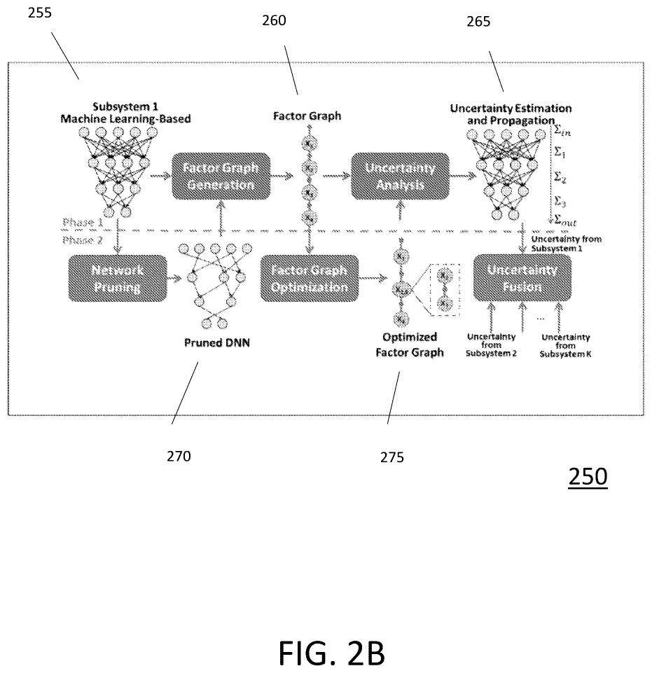

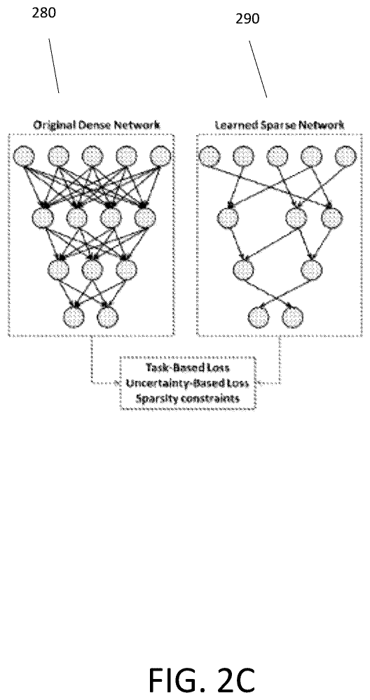

An ML model/algorithm of the present principles, such as the ML model/algorithm 103 can be trained using a plurality (e.g., hundreds, thousands, millions) of instances of labeled content in which the training data comprises a plurality neural networks and associated graphical representations to train an ML model/algorithm of the present principles to translate a neural network into a graphical representation in accordance with the present principles. While in the embodiment of FIG. 1B, the factor graph formulation system directly translates the neural network into a factor graph, in some embodiments of the present principles, factor graph structures can model the same neural network using different factorizations of the probability density over the network. Furthermore, in some embodiments, a graphical representation of the present principles, such as a factor graph structure of the present principles, can be optimized for different objectives (e.g. computational efficiency). For example, FIG. 2A depicts a graphical representation of a functionality of a graphical representation formulation system 200 in accordance with an alternate embodiment of the present principles. The embodiment of FIG. 2A comprises a neural network 210 (illustratively a ResNet18 neural network), a direct factor graph 220, and a second factor graph 230. The second factor graph 230 of FIG. 2A minimizes the number of network layers modeled in a graphical representation formulation system of the present principles to compute the network's output uncertainty without sacrificing an aleatoric uncertainty estimation.

In the embodiment of FIG. 2A, the direct factor graph 220 includes nodes for every layer of the ResNet18 neural network 210 with factors for all layer connections. In the second factor graph 230 of FIG. 2A, only two sets of factor graph nodes are used; one set representing a state of the input to the ResNet18 neural network 210, and the other set representing the state of the target layer for uncertainty propagation (i.e. output of ResNet18's fully connected layer, X_{FC} in FIG. 2A). The uncertainty propagation approach of FIG. 2A can be applied to any layer of a trained neural network and, following a similar procedure, different factor graphs can be instantiated to propagate input uncertainties to any intermediate layers of the ResNet18 neural network (e.g., the 2D adaptive average pooling layer, labeled X_{AP} in FIG. 2A.

In some embodiments, the functionality of the graphical representation formulation system 200 of FIG. 2A can be illustratively implemented in two phases. For example, FIG. 2B depicts an embodiment of the functionality of the graphical representation formulation system 200 of FIG. 2A when implemented as a two-phase process. In the graphical representation formulation system 250 of FIG. 2B, in a first phase (Phase 1), direct factor graph formulation is used to propagate and quantify aleatoric uncertainty for a neural network 255 (e.g., diverse DNN architecture). That is, in Phase 1 of the graphical representation formulation system 200 of FIG. 2B, factor graph generation of the present principles is applied to the neural network 255 to produce a factor graph 260. In Phase 1, data is propagated through the factor graph 260 to determine the uncertainty estimation and propagation 265 for the neural network 255. That is, in some embodiments of the present principles, by propagating data through the factor graph 260 and comparing the data before the propagation and after the propagation through the factor graph 260, the uncertainty estimation and propagation 265 for the neural network 255 can be determined (described in greater detail below with reference to experiments performed). The data propagated through the factor graph 260 can be any data (e.g., audio, visual, audio/visual, sensor data, such as IMU data, etc.) that can be processed by the neural network 255.

In a second phase (Phase 2), which in some embodiments can be run in parallel with Phase 1, network pruning can be applied to the neural network 255. Factor graph generation of the present principles is then applied to the pruned neural network 270 to produce the factor graph 260. In Phase 2, factor graph optimization can be applied to the factor graph 260 to produce an optimized factor graph 275. Data can then be propagated through the optimized factor graph 275 to determine the uncertainty estimation and propagation 265 for the neural network 255.

In accordance with the present principles, an uncertainty estimation and propagation for each layer of a neural network, such as the neural network 255 of FIG. 2B, can be determined as described in FIG. 2B. As further depicted in FIG. 2B, an uncertainty of multiple subsystems/neural network layers (either learning- or modeling-based) can be fused using factor graphs as the statistics-based estimator. In the graphical representation formulation system of FIG. 2B, factor graph formulation is again utilized for modeling DNN uncertainty propagation as a nonlinear optimization problem, by treating neural network layers as discrete time steps and their values as states (large circle X₁) and connections among neural network layers as different factors (edges with dots) across states. In the embodiment of FIG. 2B, the Jacobian matrix and the noise matrix for each factor come from the weights and biases across correspondent network layers. Output covariance then can be accurately estimated by propagating input uncertainty (i.e., aleatoric uncertainty) through the neural network states/factors.

The embodiments of the factor graph formulation of FIGS. 2A and 2B can be implemented by the optimization module 104 of the graphical representation formulation system 100 of FIG. 1A and can improve computation speed of uncertainty estimation from at least two perspectives: (1) Network Pruning with Sparsity Regularization, and (2) Factor Graph Optimization. The first perspective leverages network pruning techniques to learn an efficient sparse network that mirrors the behavior of the original dense network. The second perspective performs faster factor graph inference, through uncertainty analysis in a hierarchical manner inside neural networks. A 10× computational efficiency in covariance estimation can be achieved using such embodiments of a factor graph formulation of the present principles over current baseline approaches.

More specifically, in some embodiments, the network pruning with sparsity regularization of the present principles can be used to improve the computational efficiency in covariance generation. As recited above, network compression (e.g., pruning) reduces DNN redundancy (10-100× reduction in model size) for improved computational, storage, and energy efficiency without degrading task performance. That is, the network pruning techniques can learn a sparse network that can mirror the behavior of the original dense network in terms of performing the intended task and, more importantly, propagating data uncertainty can be developed in accordance with the present principles. For example, FIG. 2C depicts a high-level diagram of a dense DNN 280 that was pruned into a learned Sparse network 290 in accordance with one embodiment of the present principles. In some embodiments, L1 regularization can be implemented to prune a network in accordance with the present principles. This regularization method is inspired by classic sparse estimation algorithms based on Lasso regularization, which features both simple formulation and solid theoretical basis from statistical learning. Given a network trained with respect to task objectives, the network can be finetuned with an auxiliary loss term based on the L1-norm (sum of absolute magnitude) of model weights/intermediate features. The L1 penalty term will regularize the training to minimize task loss while encouraging sparsity in effective neurons and parameters. In some embodiments, following the regularized training, magnitude-based pruning via shrinkage thresholding can be applied to determine the sparse network. For further reduction in computational complexity of the proxy network, structured pruning, which not only reduces the number of parameters but also decreases computational complexity of the model, can be used.

In some embodiments, to ensure that the learned proxy network not only preserves task performance but also faithfully captures how uncertainty propagates through the original network, additional constraints to enforce the consistency of uncertainty propagation can be imposed. Specifically, a loss term can be incorporated to minimize the difference between sample covariance at intermediate features between the original and proxy network. Experimental comparisons of the uncertainty propagation in the full vs. pruned networks can be performed.

In some embodiments as described above, Factor Graph Optimization can be implemented to perform uncertainty analysis in a hierarchical manner using factor graphs. This method is important specifically for deep and large DNN models. Factorization of a joint probability function in a factor graph, which models the uncertainty propagation through a DNN, can be applied at different levels of granularity. For example, each layer of a residual block or a series of residual blocks can be modeled as state transitions in ResNet. Similarly for a transformer, high-level analysis can be performed at encoder/decoder level and drilled down into to an individual encoder/decoder when needed (i.e., to understand possible different covariance propagation patterns among multiple heads). In other words, for some portions of a transformer, the uncertainty propagation can be approximately calculated at the block level instead of the layer level. A factor graph for a transformer designed at the block level can save roughly ⅔ of factors and corresponding updates in uncertainty estimation in comparison to a factor graph designed at the layer level.

Implementing only two types of factors modeled as Gaussian densities, prior-factors and between-factors in accordance with embodiments of the present principles, can be defined according to equation two (2) and equation three (3), as follows:

$${ϕ}_{i} ( {x}_{i n} ) = η ( {\sum }_{in} ) exp ( - \frac{1}{2} {‖ {x}_{i n} - {μ}_{i n} ‖}_{{\sum }_{in}}^{2} ) \qquad ( 2 )$$

$${ϕ}_{i} ( {x}_{i n} , {x}_{o u t} ) = η ( {\sum }_{o u t} ) exp ( - \frac{1}{2} {‖ {r}_{18} ( {x}_{i n} ) - {x}_{o u t} ‖}_{{\sum }_{o u t}}^{2} ) . \qquad ( 3 )$$

In equations two (2) and three (3), prior-factors, ϕ(xᵢₙ), estimate the input uncertainty prior to the neural network. These priors correspond to the irreducible data uncertainty, or more commonly the “sensor model” within factor graph state estimation. The between-factor, ϕ(xᵢₙ, xₒᵤₜ), estimates the output uncertainty and the relationship to the input uncertainties, which are transformed by the network's operations. The between-factors can correspond with “motion models” from factor graph state estimation literature. In Equations 2 and 3, to save space,

$$η ( \sum ) = \frac{1}{\sqrt{2 π \sum }}$$

has been defined as a normalizer and ∥θ−μ∥_{Σ}²≙(θ−μ)^{T}Σ⁻¹(θ−μ) as the squared Mahalanobis distance with covariance matrix Σ.

In some embodiments, a graphical representation formulation system of the present principles can implement multiple input priors from the intuition that additional priors to estimate the same output uncertainty should improve estimation. While Equation three (3) is written for a single input node given available space, in some embodiments the binary between-factor can be extended to an (n+1)-wayfactor, which can result in improved uncertainty propagation performance by using multiple priors in a factor graph formulation of the present principles.

With the factor graph formulation structure/functionality of the present principles, such as the factor graph formulation functionality of FIG. 1B, FIG. 2A and FIG. 2B, uncertainty propagation can begin after initializing the values and uncertainties for all variable nodes and Jacobians for all factors. While the factor graphs formulations of the present principles are not limited by the choice of distribution to model variable nodes, some embodiments of the present principles implement Gaussian densities for variable nodes to leverage existing factor graph libraries. In some embodiments, the initial value of each variable node within the factor graph is initialized to the corresponding value within the subject neural network or a sampled input value, according to the variable node set. The uncertainties for variable nodes (i.e. covariances) are initialized using either a known sensor noise model (e.g., input variable nodes) or using an identity matrix with diagonal terms scaled close to zero for unknown uncertainties (e.g., output variable nodes). In some embodiments, the Jacobian matrix for each factor comes from the parameter values (e.g. weights and biases) for correspondent layers of the neural network. After defining the factor graph structure and initializing variable nodes, uncertainty propagation is used to estimate the predictive uncertainty caused by the input noise. In such embodiments, inference with covariance propagation over a factor graph corresponds to finding the maximum a posteriori (MAP) estimate of the variable nodes. Each factor encodes a likelihood that should be maximized by adjusting the estimates of the involved variable nodes. The optimal estimate is the one that maximizes the likelihood of the entire graph, ϕ(X), according to equation four (4), which follows:

$$\hat{X} = {arg}_{x} max ( {\prod }_{i} {ϕ}_{i} ( {X}_{i} ) ) \qquad ( 4 )$$

Maximizing the factored representation in Equation four (4) is equivalent to minimizing the negative log likelihood. In the Gaussian case, this leads to a nonlinear least-squares problem. To solve the full nonlinear optimization problem, the incremental smoothing and mapping (iSAM2} algorithm provides an efficient sparse nonlinear incremental optimization, in some embodiments, using the Bayes Tree data structure. That is, in some embodiments, the Bayes Tree is obtained by converting the factor graph into a Bayes Net via the Variable Elimination Algorithm and identifying all cliques within the Bayes Net. The Bayes Tree representation can then be used to compute the clique marginals, from which the marginal (i.e. covariance) of each node can be computed. The covariance of the output node within the factor graph, which corresponds to the network's output, then provides the aleatoric uncertainty.

In some embodiments, in addition to Gaussian models, the factor graph formulation approach of the present principles can also support non-Gaussian noise distributions, including a robust error model based on the Huber loss function. A suitable noise model to represent different sensor noise and environmental conditions, which are intrinsic variations in system inputs, can be chosen. These models are also extendable to general-purpose methods that can be easily configured and re-used by other sensors which share the same noise characteristics. Also, specific noise models are implemented for specific sensors. One example is the 3-axis Magnetometer, whose noise is modeled using a multi-modal distribution, leveraging an expectation maximization (EM) method for mode selection.

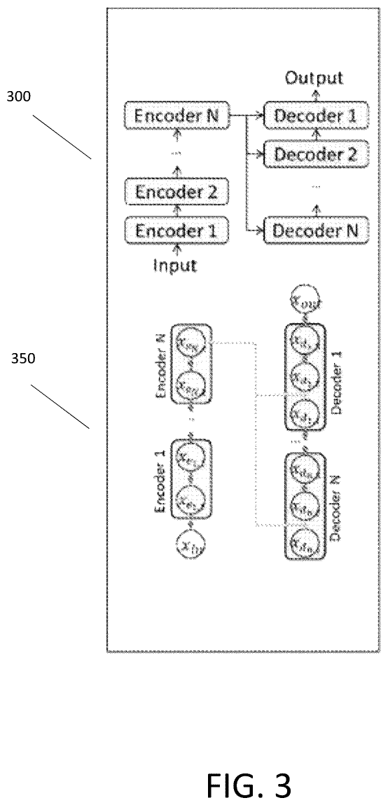

In a basic implementation, a transformer consists of a stack of N structurally identical encoders and a stack of N structurally identical decoders. For example, FIG. 3 (Top) depicts a standard transformer 300. In FIG. 3, the transformer 300 includes a plurality of encoders, encoder 1 . . . encoder N, and a plurality of decoders, decoder 1 . . . decoder N. Each encoder of the transformer 300 of FIG. 3 contains a multi-head self-attention layer allowing the encoder to consider inputs at other positions when encoding each input element (e.g., a word in a sentence), and a feed-forward layer passing the outputs from self-attention to the next encoder. Each decoder of the transformer 300 of FIG. 3 contains the same two layers with an additional multi-head attention layer in between which takes in the outputs from the last encoder. In the transformer 300 of FIG. 3, for each layer in the encoder and the decoder, a residual connection is employed followed by layer normalization. FIG. 3 further depicts a factor graph formulation 350 (bottom) for the encoders and decoders of the transformer 300 in accordance with an embodiment of the present principles. In the embodiment of FIG. 3, the inside edge connections illustratively between the nodes are used to represent binary factor containing only two state variable nodes, for example, a factor function p (x₁ x₀) describing a feed forward layer x₁=Wₓ_{₀}+b. The outside connections represent long-range or multiple state variables, for example, the connection between encoder, N, and individual decoders, N. Using the factor graph formulation 350 of FIG. 3, data uncertainty across each encoder and decoder, including from the input to the output when accumulated, can be analyzed.

Although the transformer of FIG. 3 illustratively comprises encoders and decoders, in some embodiments of the present principles, a transformer can include only encoders (e.g., BERT), or include only decoders (e.g., GPT NB). In some embodiments, the most important versions of transformers, such as GPT4, are transformers with decoder-only architecture.

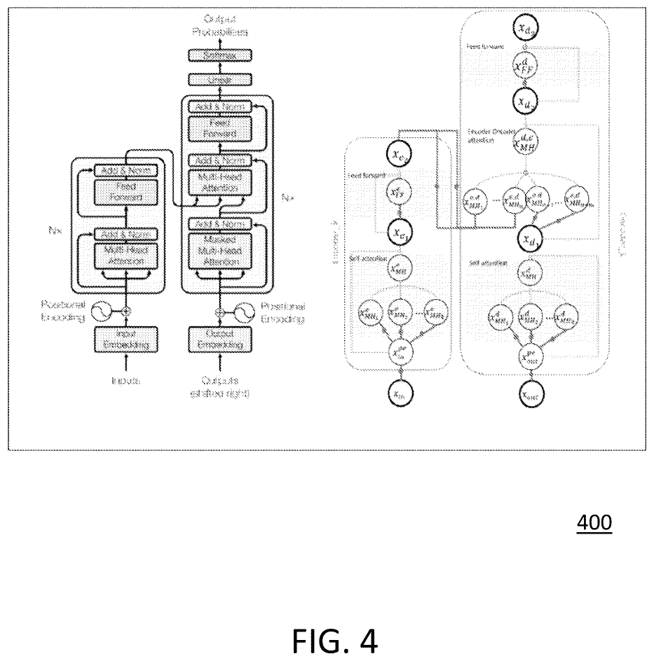

In some embodiments, for more fine-grained uncertainty analysis, factor graph formulations of the present principles can be designed to model the network connections within each encoder and decoder. For example, FIG. 4 depicts a factor graph formulation 400 that can capture the structure of multi-head self-attention and residual connections in accordance with an embodiment of the present principles. For example, with regards to FIG. 4, factor function p(x_{MH}|x_{MH1}, x_{MH2}, . . . , x_{MHk}) describes the multi-head self-attention layer in which self-attention calculation is performed multiple times with different weight matrices, projecting input embeddings into different representation subspace resulting in multiple attention heads. A linear transformation is then applied to the concatenation of multiple attention heads to output the overall attention, x_{MH}. The long-range factor can also be used to model residual connection applied around each feed forward or attention layer where the input and output state variable of the layer as well as the summation are connected in the factor graph.

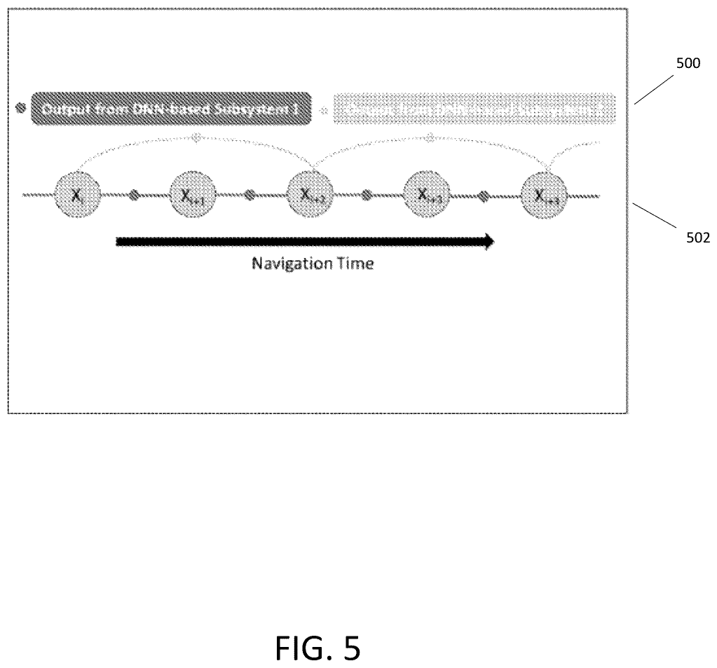

In some embodiments, a POC multi-sensor GPS-denied navigation system can be developed, by concatenating DNN-based subsystems for uncertainty fusion. For example, FIG. 5 (Top) depicts a high-level block diagram of a concatenated DNN-based subsystem 500. As further depicted in FIG. 5 (Bottom), a factor graph formulation 502 of the present principles, which can be used in fusing outputs (with uncertainties) from multiple traditional (e.g., non-ML) sub-systems, can be used to improve overall accuracy, as the statistics-based estimator for fusion.

In an experiment, the uncertainty propagation approach of a factor graph formulation of the present principles was evaluated against three baselines across classification and regression problems. The experiment spanned four datasets, MNIST, CIFAR-10, M2DGR, and Tiny-Imagenet and three neural network architectures, MLP, ResNet, and Swin. In each experiment, a neural network was trained for a task on the correspondent dataset and then evaluated for how well each approach could propagate input uncertainties. Across all experiments, improved performance was observed by using an embodiment of a factor graph formulation of the present principles for propagating input uncertainty when compared to the baselines.

More specifically, the uncertainty propagation performance of the present principles was evaluated by comparing the output uncertainties estimated in each embodiment to a ground truth output uncertainty reference. A variety of baselines were tested from related works in addition to the approach of embodiments of the present principles. For example, Lightweight probabilistic neural networks (LPN) train a lightweight probabilistic deep neural network to predict the variance for each network output. However, variance alone ignores the off diagonal terms of network output uncertainties. The unscented transform (UT) and Extended-Kalman filter (EKF) are implemented to estimate the full covariance of network output uncertainties.

In one embodiment of the experiment, Monte Carlo sampling was used as a reference for the network's true aleatoric uncertainty by computing the sample mean and covariance of network outputs generated from sampling the true input uncertainty distribution until convergence. The 2-Wasserstein distance is a metric to describe the distance between two probability distributions, in the experiment, Gaussians. Each evaluated method was compared to the Monte Carlo sampling reference by computing the 2-Wasserstein distance between the estimated aleatoric uncertainties of each (i.e. covariance matrices). This procedure was repeated for a set of unseen evaluation examples to test for statistical significance. To test for statistical significance in each experiment, a non-parametric one-way repeated measures analysis of variance (Friedman's test) was performed followed by a post-hoc analysis to identify which experimental groups differ (Nemenyi's test). Friedman's and Nemenyi's tests were used because the 2-Wasserstein distance values in each experiment were not normally distributed, according to Shapiro-Wilk tests.

In an image classification experiment, controlled input uncertainties were simulated to evaluate each method of the present principles because ground truth data was unavailable (i.e. true pixel values absent of sensor noise like quantization, heat, etc.). In the experiment, input images were corrupted by assuming that each measured pixel value was drawn from a Gaussian distribution centered at the true pixel value with some standard deviation, σ, and the image was blurred with a varying kernel size, k. The combination of these noise types effectively resulted in corrupting the image with additive Gaussian noise that can be locally correlated when blurring is included (i.e. diagonal or semi-diagonal covariance matrix). For each experiment, four experimental cases were evaluated from the combinations of low (σ=0.05) or high (σ=0.2) white noise and whether blurring did (k=5) or did not occur (k=1).

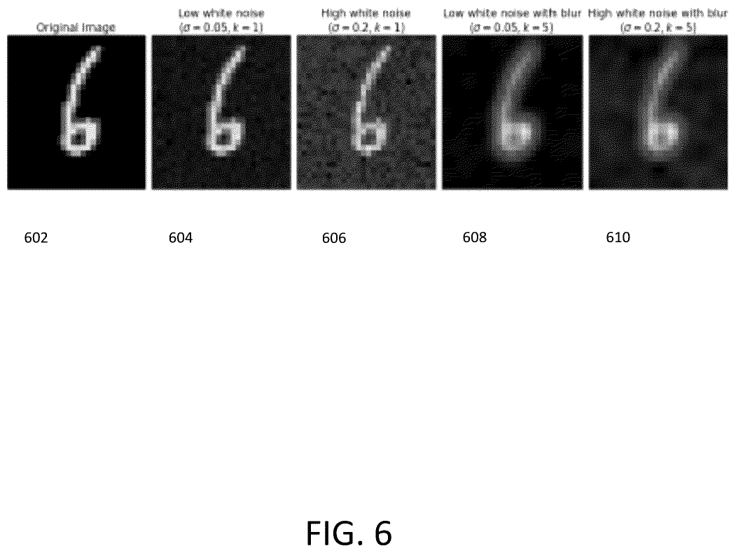

FIG. 6 depicts an original MNIST image 602 and four examples of the MINST image having noise added. For example, in FIG. 6, a first noise image 604 includes low white noise (σ=0.05) and no blurring added to the original image; a second noise image 606 includes high white noise (σ=0.2) and no blurring (k=1) added to the original image; a third noise image 608 includes low white noise (σ=0.05) and blurring (k=5) added to the original image; and a fourth noise image 610 includes high white noise (σ=0.2) and blurring (k=5) added to the original image.

In the experiment, input uncertainties were propagated for a four-layer MLP with ReLU activations trained to classify MNIST digits. The MLP was trained to an accuracy of 98% using an 80/20 split for training and testing with uncorrupted images. Each uncertainty propagation approach of the present principles was then evaluated against the Monte Carlo sampling reference using 2-Wasserstein distances for 500 example images from the MNIST test set with each of the controlled noise settings previously discussed. The evaluation was repeated for both the MLP output layer and the third layer of the MLP to demonstrate that factor graph formulation embodiments of the present principles can propagate input uncertainties to any layer within the target network by altering the factor graph.

Before the MNIST evaluation, an ablation study was performed using the validation set to select an appropriate number of input variable nodes for the factor graph. The input uncertainties were propagated using a factor graph approach of the present principles for 500 example images from the MNIST validation set in both the low and high white noise settings, without blurring. In the experiment, the aleatoric uncertainty estimated by the factor graph was compared to the Monte Carlo sampling reference using 2-Wasserstein distance for all 500 examples. The procedure was repeated for 1 to 9 input variable nodes within the factor graph of the present principles.

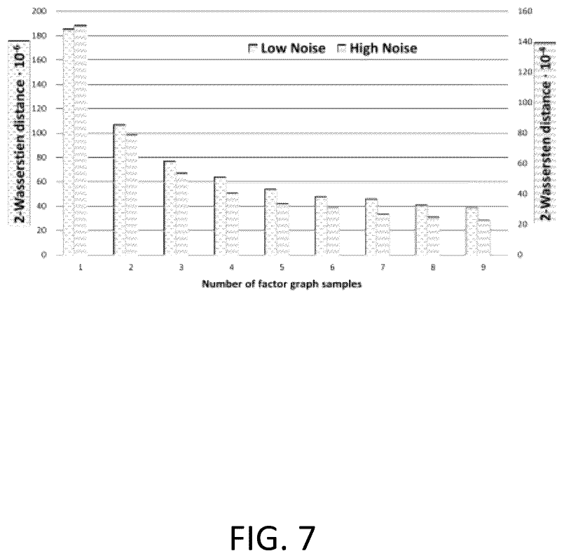

From the experiment, it was observed that using more than 4-5 input variable nodes in a factor graph formulation of the present principles yields diminishing returns. For example, FIG. 7 depicts a Table of the results of the ablation study performed in the experiment. More specifically, FIG. 7 depicts the 2-Wasserstein distance averaged across all 500 examples for each ablation. As depicted in FIG. 7, the rate of performance improvement is less than 20% when using 4 or more samples and every additional sample increases the uncertainty propagation time.

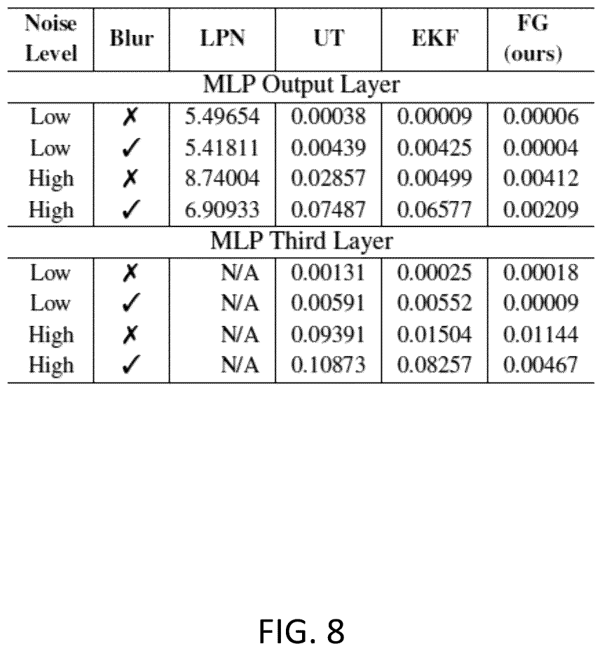

From the MNIST experiments, it was determined that the uncertainty propagation of the present principles provided statistically significant (p-value=0.001) improvements in performance when compared against all baselines. For example, FIG. 8 depicts a Table depicting the MNIST Uncertainty Propagation Performance for MLP output and 3rd layer measured using 2-Wasserstien Distance in a factor graph formulation system in accordance with an embodiment of the present principles (lower is better). In the Table of FIG. 8, the first column lists the noise level, the second column list whether or not blur was included, the third, fourth, and fifth columns list the Uncertainty Propagation Performance for LPN, UT, and EKF, respectively, and the sixth column lists the Uncertainty Propagation Performance for a Factor Graph formulation of the present principles. As depicted by the Table of FIG. 8, Lightweight probabilistic neural networks (LPN baseline) show the worst performance across experimental cases because the approach trains a network only to provide variances of the network outputs, which ignores off-diagonal terms within covariance matrices of output network uncertainties. Additionally, LPN was not evaluated in the MLP third layer experiment as LPN only provides uncertainties for network outputs. The UT baseline relies on sampling sigma points while the EKF baseline relies on analytical formulas to propagate the input uncertainty. As depicted in the Table of FIG. 8, both underperformed against a factor graph formulation of the present principles. A factor graph formulation of the present principles seems to outperform the tested baselines because it incorporates both sampling and analytical techniques to propagate uncertainties.

In a different experiment, input uncertainties were propagated for a ResNet18 deep neural network trained to classify CIFAR-10 categories. The experimental setup mimicked the setup of the MNIST experiment. A trained ResNet18 was used with an accuracy of 93% on the test set of CIFAR-10. Note, the LPN baseline was excluded from this experiment as the LPN cannot propagate the uncertainties for a frozen, trained network (i.e., the ResNet18 would need to be retrained to additionally provide classification variances) and LPN exhibited poor performance in the MNIST experiment. The remaining methods were evaluated against the Monte Carlo sampling reference using 2-Wasserstein distances for 500 example images from the CIFAR-10 test set with each of the controlled noise settings previously discussed.

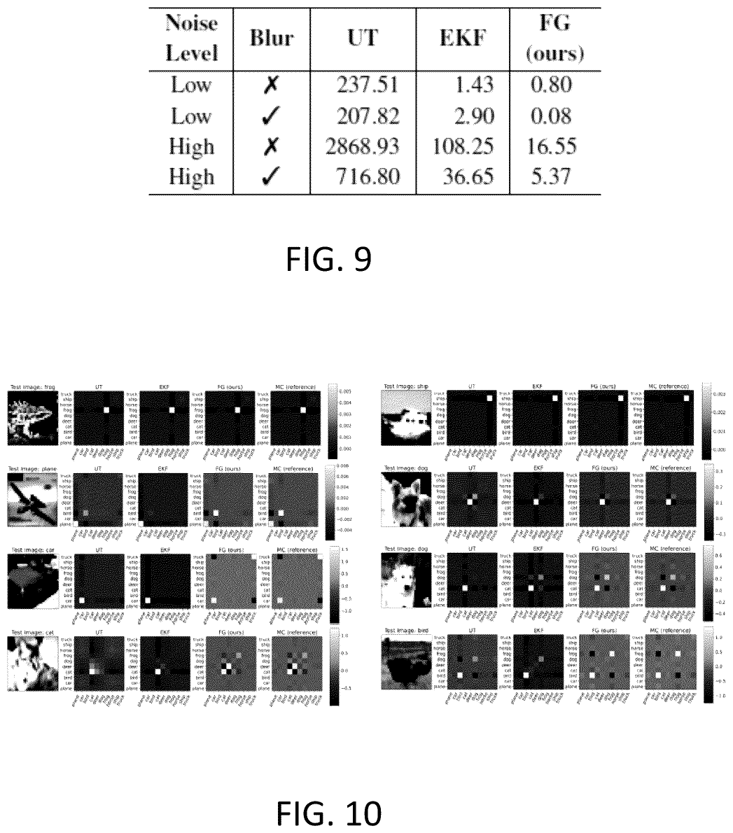

Uncertainty propagation using Factor Graph formulation of the present principles provided improved performance over the other tested baselines in the CIFAR-10 experiments, as summarized quantitatively by the Table of FIG. 9 and qualitatively by the images in FIG. 10. That is, FIG. 9 depicts a Table of CIFAR-10 Uncertainty Propagation Performance for ResNet18 measured using 2-Wasserstien Distance for a factor graph formulation system in accordance with an embodiment of the present principles (lower is better).

In the Table of FIG. 9, the first column lists the noise level, the second column lists whether or not blur was included, the third and fourth columns list the Uncertainty Propagation Performance for UT, and EKF, respectively, and the fifth column lists the Uncertainty Propagation Performance for a Factor Graph formulation of the present principles. As depicted by the Table of FIG. 9, the factor graph formulation approach of the present principles provided statistically significant (p-value=0.001) improvements in performance over both baselines in all controlled noise settings except low white noise without blur (i.e. σ=0.05 and k=1). In the low white noise without blur, the factor graph formulation approach of the present principles only provides a statistically significant (p-value=0.001) improvement over the UT baseline and not the EKF baseline, presumably because of the lack of input noise and high test accuracy of the trained ResNet18.

As previously recited, the images of FIG. 10 were provided to qualitatively compare the outputs of each baseline method and the factor graph formulation method of the present principles. In the first two examples of FIG. 10, the frog and ship, it can be noted that all baseline methods perform comparably as the network is certain about the classification of the input image despite the elevated input uncertainty. In FIG. 10, below the frog and ship, are included two examples, the plane and brown dog, of increasing difficulty in terms of uncertainty propagation. In both the plane and brown dog images, the deviation of the output covariance as estimated by the other baselines, when compared to the reference output covariance, becomes more visually prevalent in addition to the increasing uncertainties as identified by the color bar magnitudes in FIG. 10. While the magnitude of elements within the covariance matrices estimated by the baseline methods deviates from the references, the set of the most uncertain classes remains the same. Finally, in the last four examples, the car, white dog, cat, and bird, the resemblance between the baseline covariances and reference covariance has degraded. In contrast, for all example images, the results for the factor graph formulation method of the present principles remains difficult to distinguish from the reference across all examples.

In a final experiment, input uncertainties were propagated for a deep neural network trained for the task of inertial odometry. The neural network was trained to regress 2D relative displacement between two time instants given the segment of inertial measurement unit (IMU) data in between. Specifically, the vanilla ResNet18 architecture was revised to receive as input a single channel and the final fully connected layer was replaced with an MLP. As input, the inertial odometry network received an N×6 tensor consisting of N IMU measurements, in which each measurement contained three (3) linear accelerations from the accelerometer and 3 angular velocities from the gyroscope. As output, the inertial odometry network estimates the 2D relative translation between two time instants, which is provided by the network as a two tuple, dx and dy. The publicly available M2DGR dataset was used, both to train the inertial odometry network and to evaluate uncertainty propagation. M2DGR is a dataset collected by a ground robot with a full sensor-suite including the Intel Realsense d435i sensor, which provides 6-axis IMU data at 200 Hz. As the dataset, 9 trajectories from M2DGR were used with ground truth trajectories obtained by a Vicon Vero 2.2 motion capture system that has a localization accuracy of 1 mm at 50 Hz. In the experiment, samples from all but one trajectory were used to train the inertial odometry network, while samples from the remaining trajectory were used to evaluate uncertainty propagation. In M2DGR, all sensors were well-calibrated and synchronized, and their data were recorded simultaneously. As a final step, the data was preprocessed to be compatible with neural network training, such as normalizing the data. In this experiment, the available sensor and ground truth data was used to estimate the input uncertainty of the IMU instead of using artificial uncertainties as in the prior experiments. IMU readings were assumed to be independent and identically distributed. The input uncertainty for the IMU sensor was measured as the sample covariance using the differences between IMU readings and the motion capture ground truthing system across available data. In this experiment, the LPN baseline was again excluded for reasons similar to the prior experiments. The remaining uncertainty propagation methods were evaluated against the Monte Carlo sampling reference using 2-Wasserstein distances for 500 samples from the held out M2DGR trajectory with the measured sensor noise model of the IMU.

Uncertainty propagation using the factor graph formulation approach of the present principles provides statistically significant (p-value=0.001) improvements in performance against all other baselines tested in the inertial odometry experiments. More specifically, in the inertial odometry experiment, the 2-Wasserstien distances were 0.384, 0.033, and 0.004 for UT, EKF, and the factor graph formulation approach, respectively. It was again observed that the factor graph formulation approach of the present principles outperformed the other baselines (e.g., UT and EKF) in this challenging and practical experimental setting.

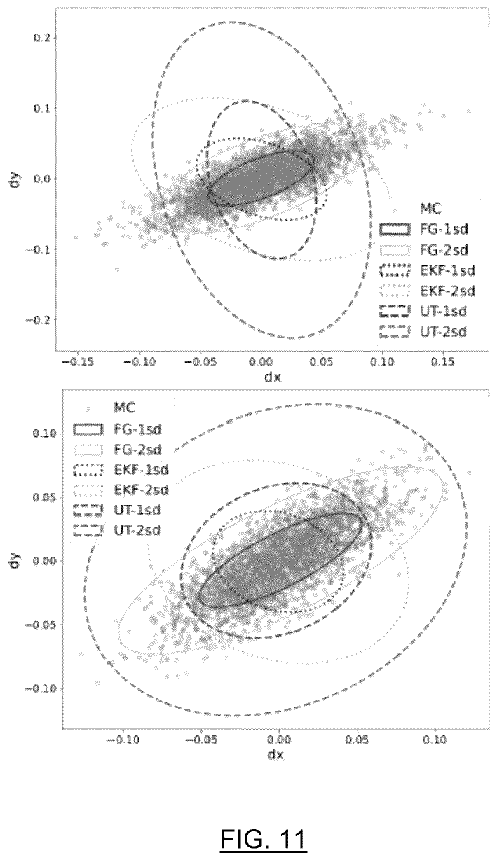

FIG. 11 depicts two graphical examples of uncertainty propagation on the above described inertial odometry network showing 3000 Monte Carlo samples as gray points with 1- and 2-standard deviation uncertainty ellipse for the output uncertainty estimated by each uncertainty propagation method of the present principles. Visually, the plots of FIG. 11 demonstrate how a factor graph formulation system of the present principles consistently provides uncertainty ellipses that better fit the Monte Carlo samples compared to the EKF or UT baseline methods.

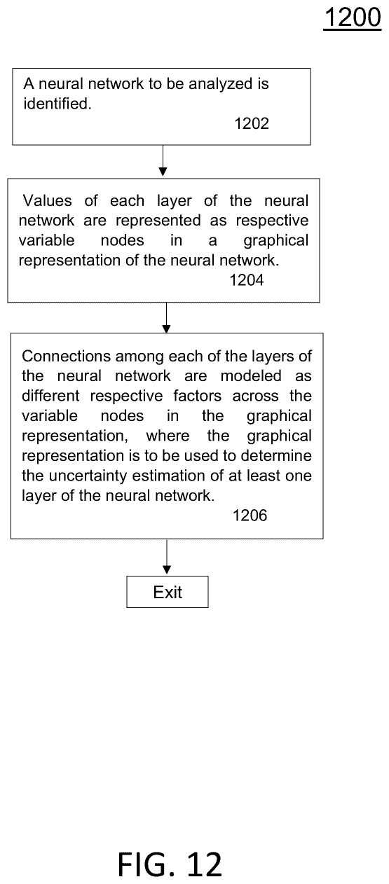

FIG. 12 depicts a flow diagram of a method 1200 for determining an uncertainty estimation of a least one layer of a neural network in accordance with an embodiment of the present principles. The method 1200 can begin at 1202 during which a neural network to be analyzed is identified. The method 1200 can proceed to 1204.

At 1204, values of each layer of the neural network are represented as respective variable nodes in a graphical representation of the neural network. The method 1200 can proceed to 1206.

At 1206, connections among each of the layers of the neural network are modeled as different respective factors across the variable nodes in the graphical representation, where the graphical representation is to be used to determine the uncertainty estimation of at least one layer of the neural network. The method 1200 can then be exited.

In some embodiments of the method can further include propagating data through the graphical representation to determine the uncertainty estimation of the neural network.

In some embodiments, in the method the uncertainty estimation of the neural network is determined without modifying the neural network.

In some embodiments, in the method the neural network can comprise any neural network architecture.

In some embodiments, the method can further include applying at least one of network pruning to the graphical representation or graph optimization to the graphical representation for edge deployment.

In some embodiments, in the method the graphical representation comprises a factor graph and the connections are modeled using Jacobian matrices and wherein the values of the Jacobian matrix elements for each factor comes from weights and biases across correspondent layers of the neural network.

In some embodiments, in the method only two sets of graph nodes are used and the two sets of graph nodes comprise one set representing a state of the input to the neural network and the other set representing a state of the target layer for uncertainty propagation.

In some embodiments, an apparatus for determining an uncertainty estimation of at least one layer of a neural network includes a processor, and a memory accessible to the processor, the memory having stored therein at least one of programs or instructions executable by the processor to configure the apparatus to identify a neural network to be analyzed, represent values of each layer of the neural network as respective variable nodes in a graphical representation of the neural network, and model connections among each of the layers of the neural network as different respective factors across the variable nodes in the graphical representation.

In some embodiments, the apparatus can further be configured to propagate data through the graphical representation to determine the uncertainty estimation of the neural network.

In some embodiments, in the apparatus the uncertainty estimation of the neural network is determined without modifying the neural network.

In some embodiments, in the apparatus the neural network can comprise any neural network architecture.

In some embodiments, in the apparatus the apparatus is further configured to apply at least one of network pruning to the graphical representation or graph optimization to the graphical representation for edge deployment.

In some embodiments, in the apparatus the graphical representation comprises a factor graph and the connections are modeled using Jacobian matrices and wherein the values of the Jacobian matrix elements for each factor comes from weights and biases across correspondent layers of the neural network.

In some embodiments, in the apparatus only two sets of graph nodes are used and the two sets of graph nodes comprise one set representing a state of the input to the neural network and the other set representing a state of the target layer for uncertainty propagation.

In some embodiments, a non-transitory computer readable medium having stored thereon at least one program, the at least one program including instructions which, when executed by a processor, cause the processor to perform a method for determining an uncertainty estimation of at least one layer of a neural network including identifying a neural network to be analyzed, representing values of each layer of the neural network as respective variable nodes in a graphical representation of the neural network, and modeling connections among each of the layers of the neural network as different respective factors across the variable nodes in the graphical representation.

In some embodiments, in the non-transitory computer readable medium, the method further comprises propagating data through the graphical representation to determine the uncertainty estimation of the neural network.

In some embodiments, in the non-transitory computer readable medium the uncertainty estimation of the neural network is determined without modifying the neural network.

In some embodiments, in the non-transitory computer readable medium the neural network can comprise any neural network architecture.

In some embodiments, in the non-transitory computer readable medium the method further comprises applying at least one of network pruning to the graphical representation or applying graph optimization to the graphical representation for edge deployment.

In some embodiments, in the non-transitory computer readable medium the graphical representation comprises a factor graph and the connections are modeled using Jacobian matrices, wherein the values of the Jacobian matrix elements for each factor comes from weights and biases across correspondent layers of the neural network.

As depicted in FIG. 1A, embodiments of a graphical representation formulation system of the present principles, such as the graphical representation formulation system 100 of FIG. 1A, can be implemented in a computing device 1300 in accordance with the present principles. That is, in some embodiments, data can be communicated to, for example, the graphing module 102 of the graphical representation formulation system 100 of FIG. 1A using the computing device 1300 via, for example, any input/output means associated with the computing device 1300. Data associated with a graphical representation formulation system in accordance with the present principles can be presented to a user using an output device of the computing device 1300, such as a display, a printer or any other form of output device.

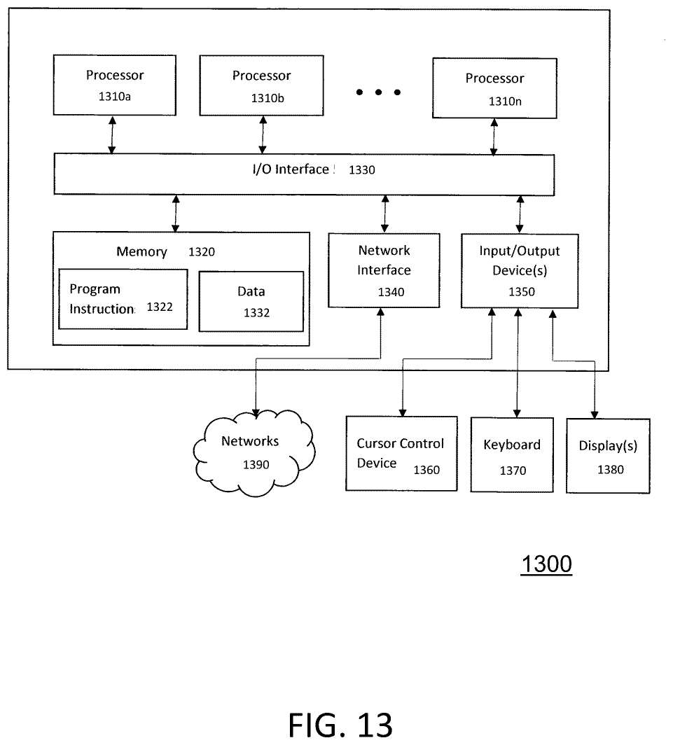

For example, FIG. 13 depicts a high-level block diagram of a computing device 1300 suitable for use with embodiments of a factor graph formulation system in accordance with the present principles such as the graphical representation formulation system 100 of FIG. 1A. In some embodiments, the computing device 1300 can be configured to implement methods of the present principles as processor-executable program instructions 1322 (e.g., program instructions executable by processor(s) 1310) in various embodiments.

In the embodiment of FIG. 13, the computing device 1300 includes one or more processors 1310a-1310n coupled to a system memory 1320 via an input/output (I/O) interface 1330. The computing device 1300 further includes a network interface 1340 coupled to I/O interface 1330, and one or more input/output devices 1350, such as cursor control device 1360, keyboard 1370, and display(s) 1380. In various embodiments, a user interface can be generated and displayed on display 1380. In some cases, it is contemplated that embodiments can be implemented using a single instance of computing device 1300, while in other embodiments multiple such systems, or multiple nodes making up the computing device 1300, can be configured to host different portions or instances of various embodiments. For example, in one embodiment some elements can be implemented via one or more nodes of the computing device 1300 that are distinct from those nodes implementing other elements. In another example, multiple nodes may implement the computing device 1300 in a distributed manner.

In different embodiments, the computing device 1300 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 1300 can be a uniprocessor system including one processor 1310, or a multiprocessor system including several processors 1310 (e.g., two, four, eight, or another suitable number). Processors 1310 can be any suitable processor capable of executing instructions. For example, in various embodiments processors 1310 may be general-purpose or embedded processors implementing any of a variety of instruction set architectures (ISAs). In multiprocessor systems, each of processors 1310 may commonly, but not necessarily, implement the same ISA.

System memory 1320 can be configured to store program instructions 1322 and/or data 1332 accessible by processor 1310. In various embodiments, system memory 1320 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 1320. In other embodiments, program instructions and/or data can be received, sent or stored upon different types of computer-accessible media or on similar media separate from system memory 1320 or computing device 1300.

In one embodiment, I/O interface 1330 can be configured to coordinate I/O traffic between processor 1310, system memory 1320, and any peripheral devices in the device, including network interface 1340 or other peripheral interfaces, such as input/output devices 1350. In some embodiments, I/O interface 1330 can perform any necessary protocol, timing or other data transformations to convert data signals from one component (e.g., system memory 1320) into a format suitable for use by another component (e.g., processor 1310). In some embodiments, I/O interface 1330 can include support for devices attached through various types of peripheral buses, such as a variant of the Peripheral Component Interconnect (PCI) bus standard or the Universal Serial Bus (USB) standard, for example. In some embodiments, the function of I/O interface 1330 can be split into two or more separate components, such as a north bridge and a south bridge, for example. Also, in some embodiments some or all of the functionality of I/O interface 1330, such as an interface to system memory 1320, can be incorporated directly into processor 1310.

Network interface 1340 can be configured to allow data to be exchanged between the computing device 1300 and other devices attached to a network (e.g., network 1390), such as one or more external systems or between nodes of the computing device 1300. In various embodiments, network 1390 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1340 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 1350 can, in some embodiments, include one or more display terminals, keyboards, keypads, touchpads, scanning devices, voice or optical recognition devices, or any other devices suitable for entering or accessing data by one or more computer systems. Multiple input/output devices 1350 can be present in computer system or can be distributed on various nodes of the computing device 1300. In some embodiments, similar input/output devices can be separate from the computing device 1300 and can interact with one or more nodes of the computing device 1300 through a wired or wireless connection, such as over network interface 1340.

Those skilled in the art will appreciate that the computing device 1300 is merely illustrative and is not intended to limit the scope of embodiments. In particular, the computer system and devices can include any combination of hardware or software that can perform the indicated functions of various embodiments, including computers, network devices, Internet appliances, PDAs, wireless phones, pagers, and the like. The computing device 1300 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 1300 can communicate with other computing devices based on various computer communication protocols such a Wi-Fi, Bluetooth® (and/or other standards for exchanging data over short distances includes protocols using short-wavelength radio transmissions), USB, Ethernet, cellular, an ultrasonic local area communication protocol, etc. The computing device 1300 can further include a web browser.

Although the computing device 1300 is depicted as a general-purpose computer, the computing device 1300 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

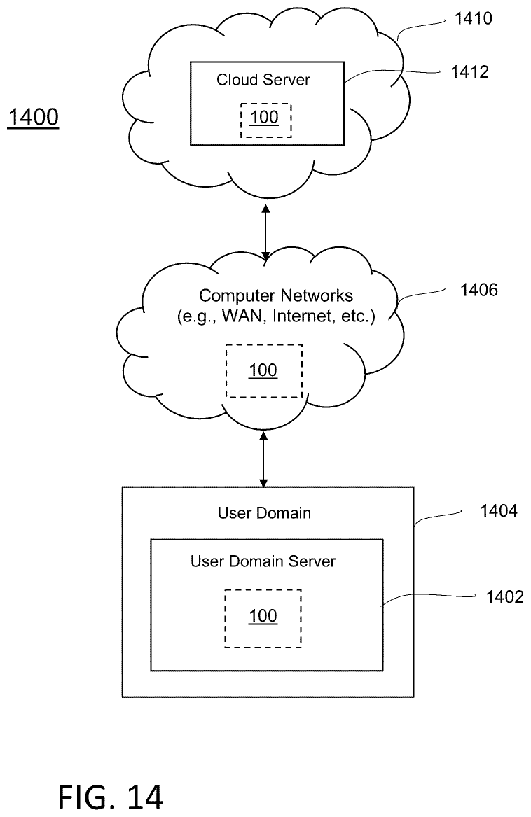

FIG. 14 depicts a high-level block diagram of a network in which embodiments of a graphical representation formulation system in accordance with the present principles, such as the graphical representation formulation system 100 of FIG. 1A, can be applied. The network environment 1400 of FIG. 14 illustratively comprises a user domain 1402 including a user domain server/computing device 1404. The network environment 1400 of FIG. 14 further comprises computer networks 1406, and a cloud environment 1410 including a cloud server/computing device 1412.

In the network environment 1400 of FIG. 14, a system for determining uncertainty propagation of neural networks in accordance with the present principles, such as the graphical representation formulation system 100 of FIG. 1A, can be included in at least one of the user domain server/computing device 1404, the computer networks 1406, and the cloud server/computing device 1412. That is, in some embodiments, a user can use a local server/computing device (e.g., the user domain server/computing device 1404) to provide orientation and location estimates in accordance with the present principles.

In some embodiments, a user can implement a system for determining uncertainty propagation of a neural network in the computer networks 1406 to provide orientation and location estimates in accordance with the present principles. Alternatively or in addition, in some embodiments, a user can implement a system for determining uncertainty propagation of a neural network in the cloud server/computing device 1412 of the cloud environment 1410 in accordance with the present principles. For example, in some embodiments it can be advantageous to perform processing functions of the present principles in the cloud environment 1410 to take advantage of the processing capabilities and storage capabilities of the cloud environment 1410. In some embodiments in accordance with the present principles, a system for determining uncertainty propagation of a neural network can be located in a single and/or multiple locations/servers/computers to perform all or portions of the herein described functionalities of a system in accordance with the present principles. For example, in some embodiments components of a graphical representation formulation system of the present principles, such as the graphing module 102 and the optimization module 104 can be located in one or more than one of the user domain 1402, the computer network environment 1406, and the cloud environment 1410 for providing the functions described above either locally and/or remotely and/or in a distributed manner.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device 1300 can be transmitted to the computing device 1300 via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

1. A method for determining an uncertainty estimation of at least one layer of a neural network, comprising:
identifying a neural network to be analyzed;
representing values of each layer of the neural network as respective variable nodes in a graphical representation of the neural network; and
modeling connections among each of the layers of the neural network as different respective factors across the variable nodes in the graphical representation, the graphical representation to be used to determine the uncertainty estimation of at least one layer of the neural network.

2. The method of claim 1, further comprising:
propagating data through the graphical representation to determine the uncertainty estimation of the neural network.

3. The method of claim 1, wherein the uncertainty estimation of the neural network is determined without modifying the neural network.

4. The method of claim 1, wherein the neural network can comprise any neural network architecture.

5. The method of claim 1, further comprising:
applying at least one of network pruning to the graphical representation or graph optimization to the graphical representation for edge deployment.

6. The method of claim 1, wherein the graphical representation comprises a factor graph.

7. The method of claim 6, wherein the connections are modeled using Jacobian matrices and wherein values of the Jacobian matrices for each factor comes from weights and biases across correspondent layers of the neural network.

8. The method of claim 1, wherein only two sets of graph nodes are used and the two sets of graph nodes comprise one set representing a state of an input to the neural network and the other set representing a state of a target layer for uncertainty propagation.

9. An apparatus for determining an uncertainty estimation of at least one layer of a neural network, comprising:
a processor; and
a memory accessible to the processor, the memory having stored therein at least one of programs or instructions executable by the processor to configure the apparatus to:
identify a neural network to be analyzed;
represent values of each layer of the neural network as respective variable nodes in a graphical representation of the neural network; and
model connections among each of the layers of the neural network as different respective factors across the variable nodes in the graphical representation.

10. The apparatus of claim 9, wherein the apparatus is further configured to:
propagate data through the graphical representation to determine the uncertainty estimation of the neural network.

11. The apparatus of claim 9, wherein the uncertainty estimation of the neural network is determined without modifying the neural network.

12. The apparatus of claim 9, wherein the apparatus is further configured to:
apply at least one of network pruning to the graphical representation or graph optimization to the graphical representation for edge deployment.

13. The apparatus of claim 9, wherein the graphical representation comprises a factor graph.

14. The apparatus of claim 13, wherein the connections are modeled using Jacobian matrices and wherein values of the Jacobian matrices for each factor comes from weights and biases across correspondent layers of the neural network.

15. The apparatus of claim 9, wherein only two sets of graph nodes are used and the two sets of graph nodes comprise one set representing a state of an input to the neural network and the other set representing a state of a target layer for uncertainty propagation.

16. A non-transitory computer readable medium having stored thereon at least one program, the at least one program including instructions which, when executed by a processor, cause the processor to perform a method for determining an uncertainty estimation of at least one layer of a neural network, comprising:
identifying a neural network to be analyzed;
representing values of each layer of the neural network as respective variable nodes in a graphical representation of the neural network; and
modeling connections among each of the layers of the neural network as different respective factors across the variable nodes in the graphical representation.

17. The non-transitory computer readable medium of claim 16, wherein the method further comprises:
propagating data through the graphical representation to determine the uncertainty estimation of the neural network.

18. The non-transitory computer readable medium of claim 16, wherein the uncertainty estimation of the neural network is determined without modifying the neural network.

19. The non-transitory computer readable medium of claim 16, wherein the method further comprises:
applying at least one of network pruning to the graphical representation or applying graph optimization to the graphical representation for edge deployment.

20. The non-transitory computer readable medium of claim 16, wherein the graphical representation comprises a factor graph and the connections are modeled using Jacobian matrices, wherein values of the Jacobian matrices for each factor comes from weights and biases across correspondent layers of the neural network.
